(19) United States
(12) Patent Application Publication
(10) Pub. No.: US 2018/0358849 A1
(43) Pub. Date: Dec. 13, 2018

(54) ROTARY ELECTRICAL MACHINE

(71) Applicant: MOTEURS LEROY-SOMER, Angouleme (FR)

(72) Inventors: Jacques SAINT-MICHEL, ANGOULEME (FR); Alexis DUTAU, SAINT-YRIEIX (FR); Michael MCCLELLAND, CHAMPNIERS (FR)

(73) Assignee: MOTEURS LEROY-SOMER, Angouleme (FR)

(21) Appl. No.: 16/061,240

(22) PCT Filed: Nov. 21, 2016
(86) PCT No.: PCT/EP2016/078318

§ 371 Date: Jun. 11, 2018

(30) Foreign Application Priority Data
Dec. 11, 2015 (FR) 1562185

(51) Int. Cl. H02K 1/20; H02K 7/14

(52) U.S. Cl. CPC H02K 1/20; H02K 7/14

(57) ABSTRACT

The invention relates to a rotary electrical machine (I) comprising a stator, said stator comprising a bundle (10) of magnetic sheets (20) made up of at least one first sub-bundle (50) and at least one second sub-bundle (60) adjacent to the first, the sheets of the first and second sub-bundles each comprising at least one fin (100) formed at the periphery of the corresponding sheet, the fins (100) of two consecutive sub-bundles being angularly offset relative to one another, in such a way as to create a disruption of the flow of a cooling fluid between the fins at the transition between the first and second sub-bundles, the machine also comprising a housing (5) at least partially covering the bundle of sheets (10), in particular a sheet-metal housing, the housing including a metal sheet wound around the bundle (10) of magnetic sheets of the stator.

The present invention relates to rotary electrical machines comprising, at the stator, a stack of magnetic laminations. The laminations conventionally form notches receiving the turns of the stator windings of the machine. In order to facilitate the cooling of the machine, it is known to form the laminations with fins and/or cooling channels.

Moreover, the machines may be classified into two families, namely machines with a frame and machines without a frame. “Frame” means a part of the machine intended to externally surround the stator, which part is cast, being, for example, made from aluminum. The “frame” is differentiated from a simple “housing”, which refers to a part formed in a simple folded or stamped metal sheet. The frame has a structural function. The housing has no structural function but a function for guiding the flow of the cooling fluid, for example air.

In the first category, the stator lamination stack is received in a frame. The application FR 2 927 736 and the patents U.S. Pat. No. 5,331,238 and U.S. Pat. No. 7,633,194 disclose machines with a frame. The stator lamination stack may include sub-stacks equipped with fins, which are arranged in a zigzag pattern along the machine, such as to create turbulences and increase the effectiveness of the cooling.

The object of the application DE 10 2012 017 293 is an electrical machine in which the lamination layering may be arranged in a frame.

In the second category, wherein the machine does not have a frame, the lamination stack directly defines the outer surface of the machine, independently of the presence of a possible housing. Machines without a frame are known from the publications WO 2007/002216, U.S. Pat. No. 8,519,580, US 2005/0067905 and WO 2005/022718. These machines more often than not use a lamination of square general shape. In WO 2007/002216, the stator lamination stack is produced with fins. In U.S. Pat. No. 8,519,580, the lamination stack is produced with internal channels.

The frame represents a relatively large cost and creates an additional thermal barrier with the outside. However, it is necessary in some machines in order to close the cooling fluid channels.

A machine without a frame may prove to be less costly to manufacture; nevertheless, the sharp edges which result from cutting the fins on the outside of the lamination stack may cause injuries when handling the stator.

The aim of the invention is to overcome at least some of the disadvantages of the known machines and further improve the electrical machines and it does so thanks to a rotary electrical machine comprising a stator, this stator comprising a magnetic lamination stack consisting of at least one first sub-stack and of at least one second sub-stack adjacent to the first sub-stack, the laminations of the first and second sub-stacks each comprising at least one fin formed at the periphery of the corresponding lamination, the fins of two consecutive sub-stacks being angularly offset with respect to one another, such as to create a disruption of the flow of a cooling fluid between the fins at the transition between the first and second sub-stack, the machine further comprising a housing at least partially covering the lamination stack, particularly a metal sheet housing.

Such a housing may be used as a sheathing and guide the cooling fluid over the outside of the lamination stack, and thus even further improve the effectiveness of the cooling. The housing may surround the stator in order to guide the cooling fluid between the fins. The housing may come into contact with the at least some of the fins, or all of the fins. The housing may be different to a frame produced by casting, as in the machines of the prior art.

The housing makes it possible to guide the cooling fluid, particularly air for example, but does not make it possible to stiffen the lamination stack. The holding structural function may be provided in other ways, for example by means of braces accommodated in holes of the lamination stack.

The housing may particularly only be in contact at points, or not all, with the lamination stack. In this case, it may be fixed by studs, for example. The housing may thus have a so-called “sheathing” role for the lamination stack, but not be used as an accommodation therefor.

The invention makes it possible to reduce, or even eliminate, due to the presence of the housing, the presence of sharp edges on the outer surface of the machine, and thus improve safety in the absence of a frame.

The housing may include a metal sheet wound around the magnetic lamination stack of the stator. The metal sheet of the housing may have a thickness less than 4 mm, preferably less than 3 mm, for example approximately 2 mm. Advantageously, a metal sheet housing may make it possible, for a very modest cost, to promote the circulation of the cooling fluid between the fins. This housing may also be used to customize the machine, by being of any color and/or by bearing any desired decoration, for example a logo.

The machine according to the invention preferably does not have a frame, without the disadvantages of the known machines without a frame and with the possibility of increased cooling.

The machine may include channels provided between the fins, at least half of these channels, or even at least two thirds of these channels, preferably at least three quarters of these channels, or even all of the channels being open outwardly.

The disruption of the flow within the channels at the transition between the sub-stacks makes it possible to increase the heat exchange between the lamination stack and the cooling fluid compared to a straight passage which only causes little turbulence. Cooling is therefore improved compared to a machine without a frame, the channels of which are straight due to using identical laminations that are superposed in order to produce them.

The invention allows improved cooling and furthermore makes it possible, if desired, to use channels with shapes which are not well suited for mounting in a frame, unlike in the prior art. The invention makes it possible to avoid having to produce castings having complicated shapes.

The machine may be a closed machine conforming to the IP 55 standard or an open machine in accordance with the IP 23 standard.

It is possible for the machine to not have closed channels. “Closed channel” means a channel formed within the magnetic lamination of the stator, which is not open radially on the outside over at least part of the length thereof, being for example defined by outer walls produced during the cutting of the laminations, as opposed to an open channel. In the invention, the machine includes open channels provided between the fins.

The laminations of the sub-stacks may be identical but angularly offset with respect to one another from one sub-stack to another by an angle of 360°/n about the axis X of the machine, wherein n is a non-zero integer, the laminations being asymmetric by a rotation of 360°/n such that the fins of the laminations offset in this manner create said disruption of the flow at the transition between the sub-stacks. The variable n may be equal to 2, 4 or 8. In this case, the laminations may include at least one external locating notch, providing information on the orientation of each sub-stack within the stack.

In an alternative, the laminations of the first and second sub-stacks may differ from one another only through the position of the fins. The fins of the laminations of the first sub-stack and the fins of the laminations of the second sub-stack may be angularly offset with respect to one another from one sub-stack to the other, for example by an angle between 0.25° and 1.25°, preferably between 0.5° and 1.0°, being, for example, approximately 0.75°.

The fins of the laminations of the first and second sub-stacks may be offset by at least 1 mm, or by at least 2 mm, preferably by at least 3 mm.

At least one of the fins of a sub-stack may be positioned between two fins of the adjacent sub-stack, such that a channel running through a sub-stack opens into two channels of the adjacent sub-stack.

The laminations may have a generally circular contour. In an alternative, they may have a generally polygonal contour, particularly square, preferably square with truncated corners.

The laminations may be symmetrical with respect to each of two mutually perpendicular planes containing the axis of the machine. In an alternative, they may be non-symmetrical with respect to each of two mutually perpendicular planes containing the axis of the machine.

Each sub-stack includes, for example, between 35 and 140 laminations. Preferably, within the stack, the laminations are all identical, apart from the offset between the sub-stacks. Each lamination may be monolithic or formed from assembled sectors.

The machine may include an alternation of at least four sub-stacks. The sub-stacks may be strictly identical in pairs, being arranged alternately. The machine may include, in an exemplary embodiment, an alternation of at least two first sub-stacks and two second sub-stacks.

The lamination stack may include holes opening via a passage laterally outwardly, braces being engaged in these holes and welded to the laminations via said passages, the holes being preferably located between the fins.

The machine may be optionally mounted in an cantilever manner on a member to be driven or driving member, particularly an air compressor, as disclosed in the patent U.S. Pat. No. 7,573,165 in particular.

The machine may include a front flange adjacent to the member to be driven or driving member, supplied with support tabs, and a rear flange without support tabs.

In an alternative, the machine includes front and rear flanges each equipped with support tabs.

The machine may be cooled with a fan driven by the shaft of the machine or with an independent motor-driven fan, attached to the lamination stack or to a flange of the machine.

It will be possible to better understand the invention upon reading the following detailed description, of nonlimiting examples for implementing the invention, and upon examining the appended drawing, wherein:

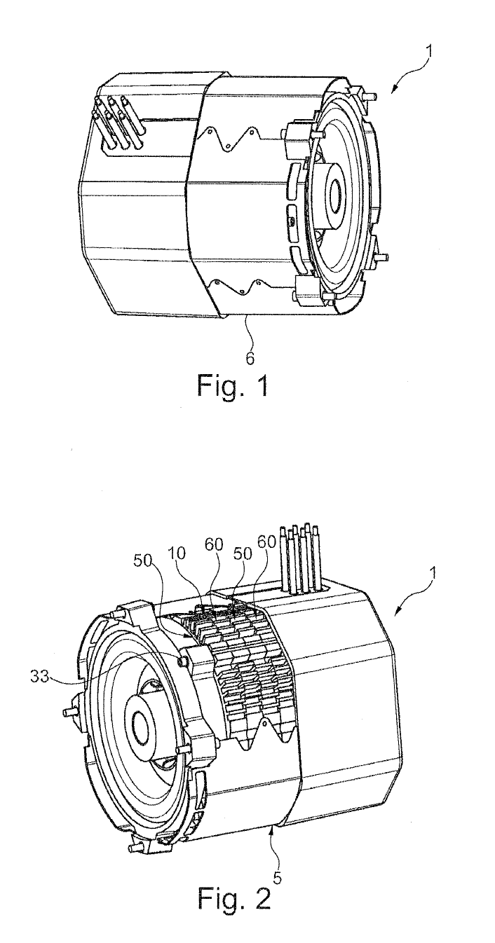

FIG. 1 shows, schematically and in perspective, a rotary electrical machine according to the invention,

FIG. 2 is a view after removal of a part of the housing,

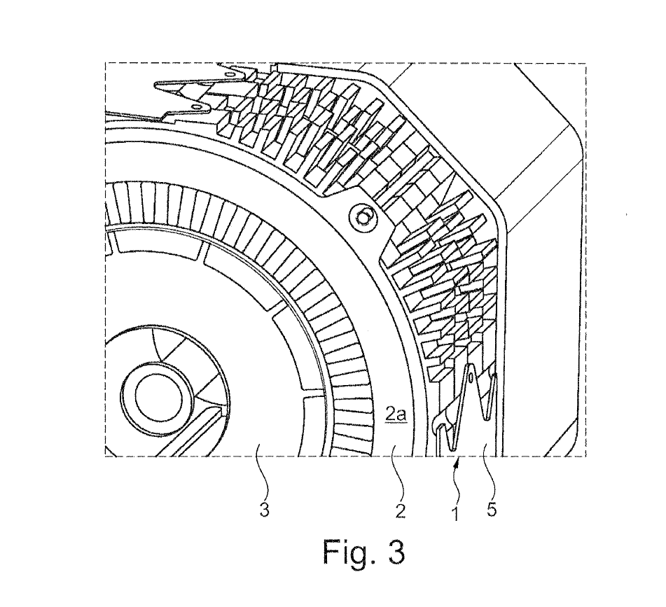

FIG. 3 illustrates the detail of FIG. 2,

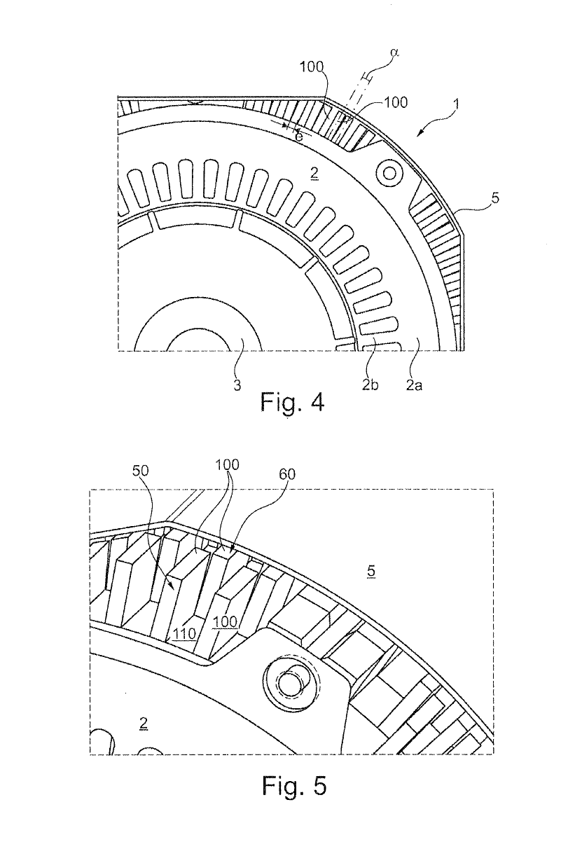

FIG. 4 is a front view, that is schematic and partial, of the detail of FIG. 3,

FIG. 5 is a close-up view, and

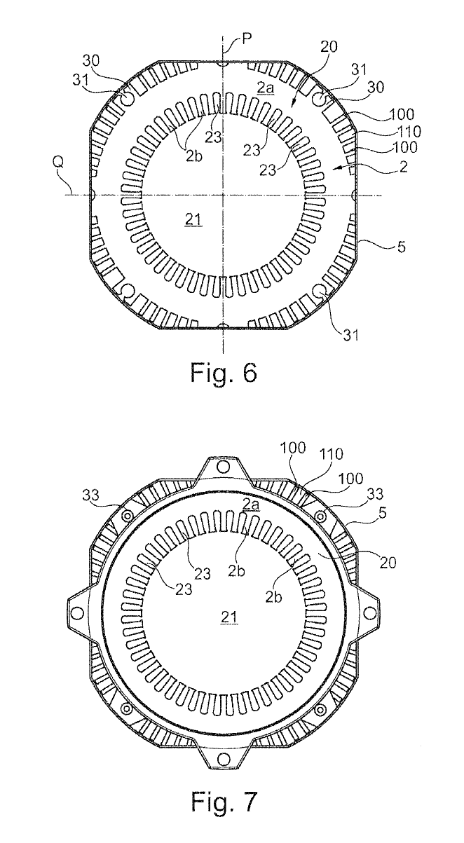

FIGS. 6 and 7 are front views, which are schematic and partial, of a magnetic lamination of the machine of FIGS. 1-5.

FIGS. 1-7 show a rotary electrical machine 1 in accordance with the invention, comprising a stator 2 and a rotor 3, accommodated in a housing 5. It may be a motor or an alternator, that is synchronous or asynchronous, optionally having permanent magnets. The machine does not have a frame. The housing 5 includes a metal sheet 6 wound around the stator. Such a housing may, thus, be used as sheathing for the machine.

The stator 3 includes a stack 10 consisting of an assembly of superposed magnetic laminations 20, one magnetic lamination of which is shown separately in a front view in FIG. 6.

Each lamination 20 is produced, for example, from magnetic steel covered with an electrical insulating varnish on the opposite faces thereof, in a manner known per se.

In the example in question, the machine has an inner rotor and each lamination 20 includes a central opening 21 for the passage of the rotor 3, into which notches 23 cut in the lamination open, which notches are provided between teeth 2b which are intended to receive the electrical conductors of the windings of the stator.

The lamination 20 has a continuous annular yoke 2a behind the notches, the outer contour generally being circular in shape.

The stack 10 itself consists of two first sub-stacks 50 and two second sub-stacks 60 which follow one another along the axis X of the stator and which are arranged alternately, each first sub-stack 50 being adjacent to at least one second sub-stack 60.

The laminations 20 of the first and second sub-stacks each include fins 100 formed at the periphery of the corresponding lamination. The laminations of the first and second sub-stacks differ from one another only through the position of the fins. Within each sub-stack, the laminations are identical. The fins 100 of two consecutive sub-stacks 50, 60 are angularly offset with respect to one another by an angle α, as may be seen in FIG. 4, such as to create a disruption of the flow of a cooling fluid between the fins 100 at the transition between the first 50 and second 60 sub-stacks, making it more turbulent. The result is an improved heat exchange between the fluid and the lamination stack and better cooling of the machine.

The fins 100 of a sub-stack 50 may be positioned between two fins 100 of the adjacent sub-stack 60, such that a channel 110 running through a sub-stack opens into two channels of the adjacent sub-stack. A fluid helping to cool the stator, for example air, may circulate in these channels 110.

The fins 100 of the laminations of the first and second sub-stacks may be offset by a distance e which may be the same as a value between a third and two thirds of the pitch of the fins and preferably half of the pitch of the fins, this distance e being measured at the surface of the yoke 2a of the stator 2.

The housing surrounds the stack 10 of magnetic laminations 20 of the stator in order to guide the cooling fluid over the outside of the lamination stack, between the fins 100. The housing may be mounted with a small clearance with respect to the end of the fins, for example a clearance of approximately 1 to 2 mm. This small clearance helps to force the cooling fluid to pass between the fins.

To this end, the machine includes channels 110 provided between the fins 100, these channels being outwardly open. The machine 1 thus has no closed channels.

The laminations 20 have a generally circular contour and are symmetrical with respect to each of two mutually perpendicular planes P and Q containing the axis of the machine.

The lamination stack includes parts 30 each crossed by a hole 31 opening via a passage laterally outwardly, braces 33 being engaged in these holes 31 and welded to the laminations via said passages, the holes 31 being located between the fins 100. The lamination stack of the stator is thus mounted by inserting four steel braces 33 into the holes 31, which are then welded completely along said passages.

The lamination 20 is preferably manufactured in a monolithic manner by cutting a strip with the final shape thereof, but, in an alternative, the stack 10 is formed by winding, on itself, a chain of sectors or by assembling sectors (each forming ¼ or ⅛ of a complete lamination) for extremely large machines. The use of sector lamination is advantageous for this type of electrical machine.

The braces 33 are possibly used for assembling the stack 10 with front and rear flanges of the machine.

The laminations 20 may also be assembled to one another by stapling, in a manner known per se.

Of course, the invention is not limited to the examples which have just been described.

The machine may include a fan rotated by the shaft of the machine, such that the channels 110 are crossed by a forced circulation of air during the operation of the machine. It is also possible to mount a motor-driven fan inside the machine in order to provide the cooling over the entire range of operation.

1. A rotary electrical machine comprising a stator, this stator comprising a magnetic lamination stack consisting of at least one first sub-stack and of at least one second sub-stack adjacent to the first sub-stack, the laminations of the first and second sub-stacks each comprising at least one fin formed at the periphery of the corresponding lamination, the fins of two consecutive sub-stacks being angularly offset with respect to one another, such as to create a disruption of the flow of a cooling fluid between the fins at the transition between the first and second sub-stack, the machine further comprising a housing at least partially covering the lamination stack,
the housing comprising a metal sheet wound around the stack of magnetic laminations of the stator.

2. The electrical machine as claimed in claim 1, not having a frame.

3. The electrical machine as claimed in claim 1, comprising channels provided between the fins.

4. The electrical machine as claimed in claim 1, not having closed channels.

5. The electrical machine as claimed in claim 1, the laminations of the sub-stacks being identical but angularly offset with respect to one another from one sub-stack to another by an angle of 360°/n about the axis of the machine, wherein n is a non-zero integer, the laminations being asymmetric by a rotation of 360°/n such that the fins of the laminations offset in this manner create said disruption of the flow at the transition between the sub-stacks.

6. The electrical machine as claimed in claim 1, the laminations of the first and second sub-stacks differing from one another only through the position of the fins.

7. The machine as claimed in claim 1, the fins of the laminations of the first and second sub-stacks being offset by at least 1 mm.

8. The machine as claimed in claim 1, comprising an alternation of at least two first sub-stacks and two second sub-stacks.

9. The machine as claimed in claim 1, at least one of the fins of a sub-stack being positioned between two fins of the adjacent sub-stack, such that a channel running through a sub-stack opens into two channels of the adjacent sub-stack.

10. The machine as claimed in claim 1, the laminations having a generally circular contour.

11. The machine as claimed in claim 1, each sub-stack comprising between 35 and 104 laminations.

12. The machine as claimed in claim 1, the lamination stack comprising holes opening via a passage laterally outwardly, braces being engaged in these holes and welded to the laminations via said passages.

13. The machine as claimed in claim 1, being mounted in an cantilever manner on a member to be driven or driving member.
